(19) United States
(12) Patent Application Publication
(10) Pub. No.: US 2015/0154630 A1
(43) Pub. Date: Jun. 4, 2015

(54) USE OF INCENTIVES TO ENCOURAGE CONTRIBUTION OF CONTENT IN A CONTROLLED MANNER

(71) Applicants: Chase HENSEL, San Francisco, CA (US); Shuangfeng Li, Beijing (CN); Liyong Chen, Beijing (CN); Ze Hong Zhao, Saratoga, CA (US)

(72) Inventors: Chase HENSEL, San Francisco, CA (US); Shuangfeng Li, Beijing (CN); Liyong Chen, Beijing (CN); Ze Hong Zhao, Saratoga, CA (US)

(73) Assignee: Google Inc., Mountain View, CA (US)

(21) Appl. No.: 13/617,799

(22) Filed: Sep. 14, 2012

(51) Int. Cl. G06F 15/16; G06Q 30/02; H04L 29/08

(52) U.S. Cl. CPC G06Q 30/0239; H04L 67/18

(57) ABSTRACT

Systems, methods, and computer storage mediums are provided for incentivizing users to contribute content in a controlled manner. A method includes receiving content and metadata associated with the content from a user. The content relates to a geolocation and the metadata includes geolocation information that relates to the content. It is then determined whether the content and the associated metadata meet a threshold of specific criteria. The specific criteria is based on a set of rules that determines an amount of points awarded to the user for providing content that satisfies the specific criteria. The specific criteria include at least a geolocation or geolocated area. If the content meets the threshold of the specific criteria, points are awarded to the user. The amount of points is based on a comparison of the content and the associated metadata with the specific criteria.

### FIELD

The embodiments described herein generally relate to encouraging users to provide digital contents.

### BACKGROUND

Geographic information systems are designed to provide geo-referenced data. The geo-referenced data may include maps or three-dimensional environments along with textual data or other content data. The content data usually relates to a geolocation that is used to display the content with the geo-referenced data. The amount and type of content provided with the geo-referenced data, however, is limited to what other users or commercial companies have provided or made available. Thus, significant portions of the geo-referenced data may have little or no additional content that can be viewed by a user. While users may submit content related to a geolocation, getting users to submit the best type of content or content related to specific geolocations remains difficult.

### BRIEF SUMMARY

The embodiments described herein include systems, methods, and computer storage mediums for incentivizing users to contribute content in a controlled manner. An example method includes receiving content and metadata associated with the content from a user. The content relates to a geolocation and the metadata includes geolocation information that relates to the content. It is then determined whether the content and the associated metadata meet a threshold of specific criteria. The specific criteria is based on a set of rules that determines an amount of points awarded to the user for providing content that satisfies the specific criteria. The specific criteria include at least a geolocation or geolocated area. If the content meets the threshold of the specific criteria, points are awarded to the user. The amount of points awarded to the user is based on a comparison of the content and the associated metadata with the specific criteria.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates a diagram showing an example geo-located map with incentivized photographic locations, according to an embodiment.

FIG. 2 illustrates an example system that may be used to incentivize users to contribute content in a controlled manner.

FIG. 3 illustrates an example system that may be used on a client device to incentivize users to contribute content in a controlled manner.

FIG. 4 is a flowchart illustrating an example method for incentivizing users to contribute content in a controlled manner.

FIG. 5 is a flowchart illustrating an example method for program developers to incentivize users to contribute content in a controlled manner.

FIG. 6 illustrates an example computer in which the embodiments described herein, or portions thereof, may be implemented as computer-readable code.

### DETAILED DESCRIPTION

The following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following detailed description refers to the accompanying drawings that illustrate example embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

This Detailed Description is divided into sections. The first section describes an example user interface showing content provided with geo-referenced data and geolocations where content needs to be provided. The second and third sections describe example system and method embodiments, respectively, for incentivizing users to contribute content in a controlled manner. The fourth section describes an example computer system that may be used to implement the embodiments described herein.

### Example Collection Grid

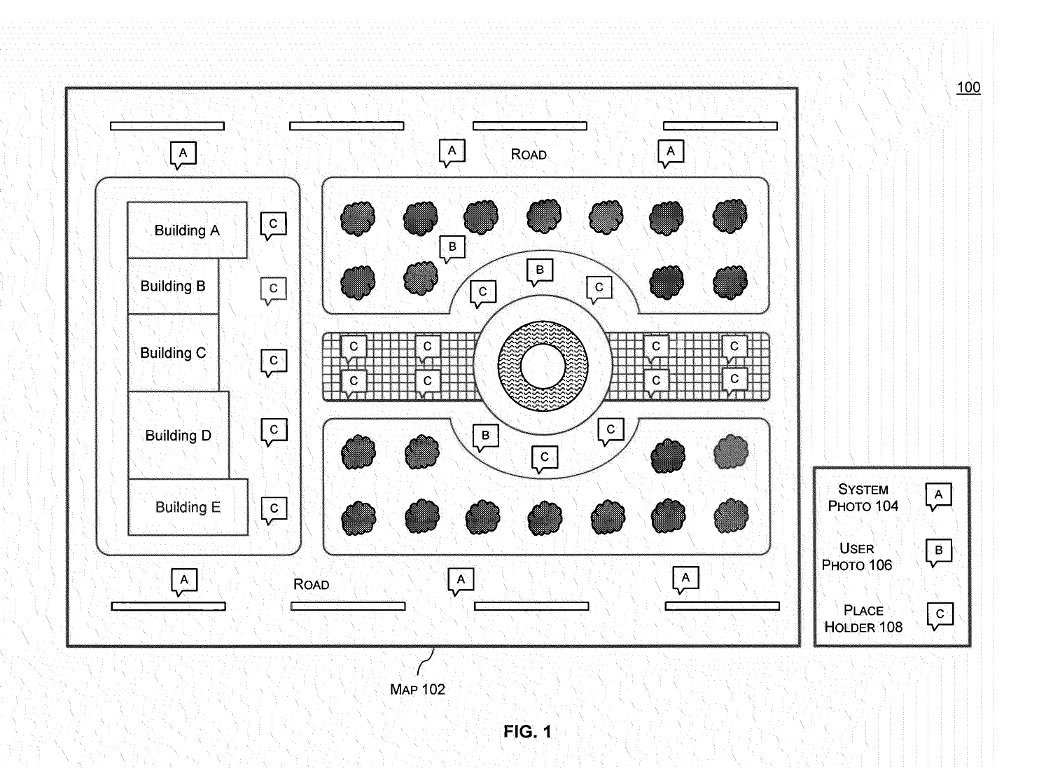

FIG. 1 illustrates a diagram 100 showing an example geo-located map 102 with incentivized photographic locations, according to an embodiment. Map 102 may be provided as geo-referenced data from a geographic information server. The geo-referenced data may include content such as, for example, photographic images, video, audio, or text. The content may be related to one or more geolocations represented on map 102. The geolocation of each provided piece of content may be displayed on map 102 as an icon or other graphical representation. Examples of content represented on map 102 include system photos 104 and user photos 106.

Each of system photos 104 and user photos 106 represent photographic images or panoramas that capture geolocations represented on map 102. System photos 104 include photographic images and panoramas that are primarily provided to the geographic information server by a commercial provider. System photos 104 may be captured through a process that captures images at a sustained frequency while the capture device traverses along a path. Examples of system photos 104 may include images captured using equipment mounted on a vehicle as the vehicle moves along a path. As each of system photos 104 is captured, the capture device may record its geolocation and associate its geolocation with the newly captured image. User photos 106 include photographic images and panoramas that are primarily provided by users of the geographic information system. User photos 106 may be captured using any capture device such as, for example, a digital camera or a mobile device with a built-in digital camera. The geolocation of each user photo 106 may be determined by a geolocation device included with the capture device, or if no geolocation device is available, by a user.

Map 102 also includes place holders 108. Place holders 108 represent geolocations where content is missing or not able to be provided by the geographic information system. To encourage users to provide content related to these geolocations, a set of rules may be created. The set of rules may be based on, for example, the type of needed content or the geolocation of the needed content. The set of rules may be used to create specific criteria that describe geolocations, geolocated areas, distribution, type, or other factors that describe the needed content. The specific criteria may be provided to users in a variety of ways so that users will be encouraged to submit content that satisfies the specific criteria. Users that provide content that satisfies at least a portion of the specific criteria may be awarded points. Points may be accumulated and used to rank users or provide users expanded access privileges that include, for example, reviewing and editing content provided by other users.

FIG. 1A is provided as an example and is not intended to limit the embodiments described herein.

### Example System Embodiments

A. Server Embodiment

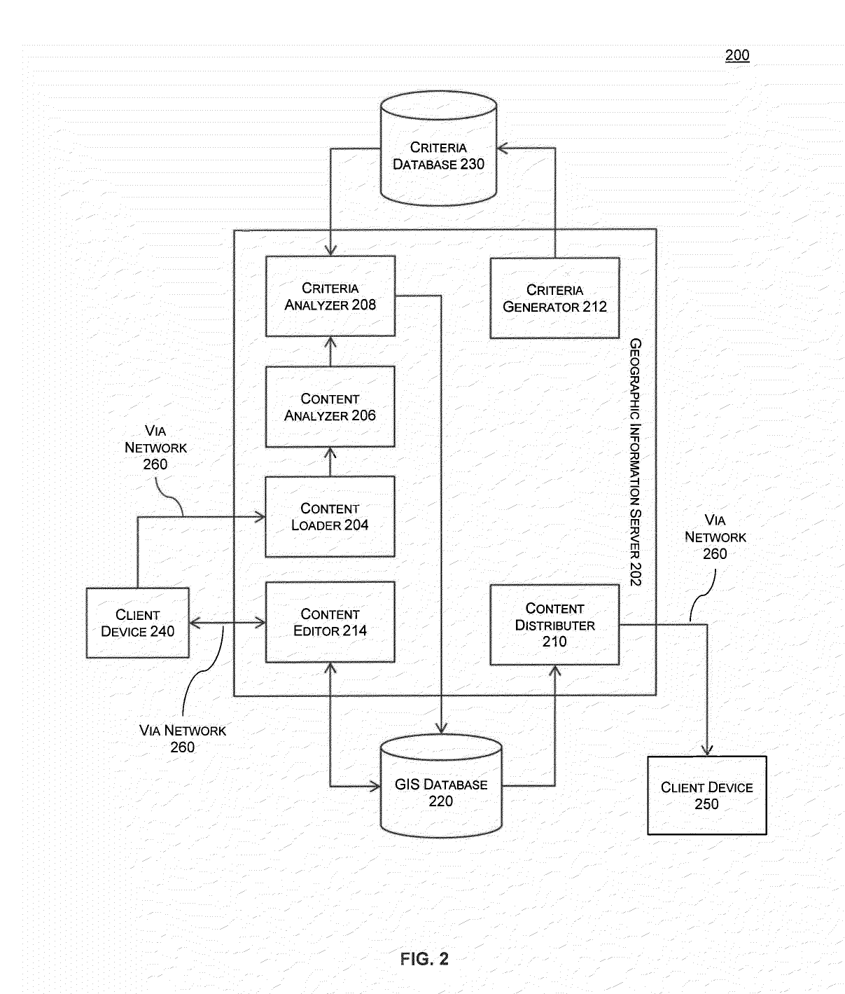

FIG. 2 illustrates an example system 200 that may be used to incentivize users to contribute content in a controlled manner. System 200 includes geographic information server (“GIS”) 202, GIS database 220, criteria database 230, client device 240, client device 250, and network 260. GIS 202 includes content loader 204, content analyzer 206, criteria analyzer 208, content distributer 210, criteria generator 212, and content editor 214.

Client devices 240 and 250 are configured to render geo-referenced data received from GIS 202 to a user at a display. The geo-referenced data may include, for example, maps, satellite images, information layers, geolocated photographic images and panoramas, or three-dimensional globes. Client devices 240 and 250 may utilize software or hardware components (e.g., computing device 220's video card) to render the geo-referenced data. Client devices 240 and 250 may be implemented on any computing device capable of rendering geo-referenced data. Computing device 240 and 250 may include, for example, a mobile computing device (e.g. a mobile phone, a smart phone, a personal digital assistant (PDA), a navigation device, a tablet, or other mobile computing devices). Computing device 240 and 250 may also include, but is not limited to, a central processing unit, an application-specific integrated circuit, a computer, workstation, a distributed computing system, a computer cluster, an embedded system, a stand-alone electronic device, a networked device, a rack server, a set-top box, or other type of computer system having at least one processor and memory. A computing process performed by a clustered computing environment or server farm may be carried out across multiple processors located at the same or different locations. Hardware can include, but is not limited to, a processor, memory, and a user interface display.

Network 260 may include any network or combination of networks that can carry data communication. These networks may include, for example, a local area network (LAN) or a wide area network (WAN), such as the Internet. LAN and WAN networks may include any combination of wired (e.g., Ethernet) or wireless (e.g., Wi-Fi, 3G, or 4G) network components.

GIS server 202 may include any geographic information system capable of serving geo-referenced data. The geo-referenced data may also include, for example, maps, satellite images, information layers, geolocated photographic images and panoramas, three-dimensional globes, navigable paths, and any other type of geographic data. The geo-referenced data may be provided using any number of communication protocols such as, for example, Hypertext Transfer Protocol (“HTTP”), Hypertext Transfer Protocol Secure (“HTTPS”), Web Map Service (“WMS”), Web Map Tile Service (“WMTS”), Web Feature Service (“WFS”), Web Coverage Service (“WCS”), Web Processing Service (“WPS”), or Web Catalog Service (“CWS”). The geo-referenced data may be retrieved from a geographic databases such as, for example, GIS database 220. The geographic database may be implemented using, for example, a file storage system implemented on GIS 202, a storage device operatively connected to GIS 202, a stand-alone database server, or a network of database servers.

GIS 202 may be implemented using a single computer server system or a distributed network of computer server systems. Computer server systems may include computing devices with, for example, one or more central processing units, memory units, and/or application-specific integrated circuits. Examples of computer server systems may include a computer, a workstation, a distributed computing system, a computer cluster, an embedded system, a stand-alone electronic device, a networked device, a rack server, a set-top box, or another type of computer system having at least one processor and memory.

GIS 202 is configured to incentivize users to contribute content in a controlled manner. In some embodiments, specific criteria are determined, at least in part, by criteria generator 212. The specific criteria may be stored at a database such as, for example, criteria database 230 and made available to criteria analyzer 208.

In order to incentivize use's to contribute content in a controlled manner, GIS 202 receives user generated content via content loader 204. The user content is analyzed by content analyzer 206 to determine, among other things, the type of the content. After at least the content type is determined for the user content, criteria analyzer 208 compares the user content to the specific criteria stored at criteria database 230. If the user content falls within the specific criteria, the user's profile is awarded points and the user content is associated with the user's profile and stored at a geographic database such as, for example, GIS database 220.

When another user requests geo-referenced data, content distributer 210 retrieves the geo-referenced data from GIS database 220. In some embodiments, the geo-referenced data may include user content associated with a user profile that has amassed enough points to get priority over content provided by other users. In other embodiments, the geo-referenced data may include user content from multiple users depending on, for example, the type of geo-reference data requested or the points associated with each user's profile. Each of these components is described below in more detail.

1. Criteria Generator

In some embodiments, GIS 202 may optionally include criteria generator 212. Criteria generator 212 is configured to generate a plurality of specific criteria. The specific criteria are based on a set of rules that define factors for awarding users for providing specific content. The set of rules may include a content type that describes the type of the content. The type of content may describe, for example, images, video, text, or any combination of content. The set of rules may also include a plurality of geolocations, geolocated areas, or geolocated offsets within a geolocated area. For example, the set of rules may indicate an award for content that includes a photographic image every 20 feet within a geolocated area. Alternatively, the set of rules may indicate an award for content that includes photographic images, reviews (e.g., text), or video related to a specific geolocation.

The set of rules may be determined based on content already available to GIS 202. For example, if GIS 202 has more content related to a first geolocated area and less content related to a second geolocated area, criteria generator 212 may build a set of rules to award more point to users submitting content related to the second geolocated area. The set of rules may also be based on user input. For example, a system administrator or one or more users may input a set of rules. The set of rules may further be based on user interaction with GIS 202. For example, if user trends show that geo-referenced data related to a specific geolocation is requested more than other geo-referenced data, GIS 202 may develop a set of rules to award users that provide content related to the more heavily requested geolocation.

Criteria generator 212 may utilize one or more sets of rules to develop specific criteria. Each specific criterion may correspond to a geolocation, geolocated area, or a plurality of geolocations or geolocated areas. Additionally, each geolocation or geolocated area may be associated with multiple specific criteria. In some embodiments, the specific criteria may be based on a content type. For example, specific criteria may be defined based on a set of rules that seeks any type of content related to a geolocation. Criteria generator 212 may utilize the set of rules to define specific criteria for each type of content supported by the system that reduces awards to users as more content of each respective type is received.

The specific criteria may directly use the set of rules or may utilize the set of rules to develop more detailed criteria for specific geolocations or geolocated areas. For example, if the set of rules seeks reviews of a business located at multiple geolocations, specific criteria may be generated for each geolocation that awards users who submit reviews of the business at a respective geolocation. Likewise, if the set of rules seeks specific photographic image coverage of a geolocation or geolocated area, specific criteria may be generated in order to award users who provide photographic images that satisfy the a coverage criteria of the specific criteria.

Sets of rules and/or specific criteria may be stored at a database such as, for example, criteria database 230. Criteria database 230 is made available to other components of GIS 202 so that GIS 202 may analyze content received form users and appropriately award the providing users. In some embodiments, criteria database 230 or any specific criteria or set of rules may be provided by other GIS systems or third party providers. When sets of rules or specific criteria are provided by another GIS system or third party, criteria generator 212 may be utilized to update, revise, or modify the sets of rules or specific criteria based on, for example, GIS 202's content or geo-referenced data.

2. Content Loader

Content loader 204 is configured to receive content from one or more users. The content is associated with metadata that includes at least geolocation information related to the content. Content loader 204 may be configured to receive specific types of content based on the types of content supported by GIS 202. Content that may be supported by GIS 202 may include, for example, photographic images, editorial reviews, business names, physical addresses, menus, pricing, or other information related to the geolocation associated with content.

Geolocation information included with metadata associated with the content may use any number of formats such as, for example, latitude/longitude or Cartesian coordinates or addresses. The geolocation information may be determined automatically from a device used to capture the content or may be provided, updated, or modified by the user. The geolocation information may depend on the content type. For example, geolocation information associated with a photographic image may indicate where the photo capture device that captured the photographic image was located when the photographic image was captured. Geolocation information associated with a business review or other text related to the business may indicate the location of the business.

In addition to the geolocation information, the metadata associated with a piece of content may also include additional data that describes the content. The additional data included in the metadata may depend on the type of the content. For example, metadata associated with photographic images or audio files may include data formatted according to the Exchangeable Image File Format (“EXIF”).

Content loader 204 may receive content from users through any number of user devices (e.g., client device 240) via a network (e.g., network 260). Content received from a user may be associated with one or more user profiles. User profiles may be created in conjunction with providing data to content loader 204 or may be created prior to the user providing any content. User profiles may include privacy settings that control the type of content that may be shared or provided to other users. The privacy settings may also control whether specific content items may be shared or provided to other users. Consequently, users may utilize the user profile to modify whether specific content is shared.

3. Content Analyzer

Content that is received by content loader 204 is processed by content analyzer 206. Content analyzer 206 is configured to determine whether the content and metadata associated with each respective content meet a threshold of specific criteria. As described above, the specific criteria is based on a set of rules that determines an amount of points awarded to a user for the user providing content that satisfies the specific criteria.

Whether the content and metadata meet a threshold of the specific criteria may depend on a number of factors such as, for example, the type of the content. For example, the specific criteria may set a threshold indicating that points will be awarded to users who submit a plurality of photographic images that evenly capture a geolocated area. Content that meets the threshold may include a plurality of photographic images that capture only a portion of the geolocated area but satisfy a spacing or distance factor of the specific criteria between the photographic images. Alternatively, the specific criteria may set a threshold indicating that points will be awarded to users who submit audio files that include a recording of sounds captured at a specific geolocation. Content meeting the threshold may include audio files that fall within a geolocation range centered on the geolocation indicated by the specific criteria.

The threshold may be adjusted based on the specific criteria, a set of rules, and/or content and geo-referenced data available to GIS 202. For example, if the threshold includes a geolocation range, the geolocation range may change as content meeting the threshold is received. In this way, user behavior may be modified in order to provide GIS 202 with new or updated content. Additionally, the threshold may be adjusted based on the quality of the content. For example, if photographic images provided by a first user include show people at a geolocation and photographic images provided by a second user include only show the geolocation, the photographic images provided by the second user may meet the threshold while photographic images provided by the first user may not. Factors used to adjust the threshold may also be used to adjust or create the set of rules or the specific criteria.

4. Criteria Analyzer

If content analyzer 206 determines that the content meets the threshold of the specific criteria, criteria analyzer 208 is configured to award points to the user based on a comparison of the content and the metadata associated with the content to the specific criteria. For example, if the specific criteria indicate that a user will be awarded points for providing a photographic image of a geolocation, the amount of point awarded to the user may be greater the closer the geolocation of the photographic image is to the geolocation of the specific criteria. Similarly, if the specific criteria indicates that a user will be awarded points for providing a plurality of photographic images approximately evenly spaced across a geolocation area, the amount of points awarded to the user may depend on the number of photographic images provided by the user or how closely the distance between the photographic images match up with the distance indicated by the specific criteria.

The amount of points awarded to a user may also depend on the quality of the content provided. For example, if the specific criteria indicates that points will be awarded to a user who provides a review of a business, the amount of points awarded may depend on factors such as, for example, the length of the review, the amount of detail in the review, or whether the facts in the review are accurate. If the specific criteria indicates that points will be awarded to a user who provides a video of a geolocated area, the amount of points awarded may depend on factors such as, for example, the video's resolution, the video's length, or the quality of the video's lighting, focus, or coverage of the geolocated area. Similar factors may be utilized to assess the quality of photographic images.

Points awarded to a user for providing content may be added to points associated with the user's profile. The points may then be used in a variety of ways such as, for example, obtaining access privileges to supervise and/or edit content in a geolocated area, review content submitted by other users, or modify sets of rules or specific criteria for a geolocation or geolocated area. The points may also be used to determine a user's position on a leaderboard. The leaderboard may rank users based on a variety of facts such as, for example, total points, the number of supervised geographic areas, or the amount of provided content.

5. Content Editor

In some embodiments, GIS 202 optionally includes content editor 214. Content editor 214 is configured to associate a user with a geolocated area when the total point awarded to the user meet a threshold point total. Geolocated areas may be determined based on any number of factors such as, for example, geo-political boundaries, proximity to landmarks, roads, or other navigable paths, or latitude/longitude coordinates. For example, a geolocated area may be based on, for example, a radius from a landmark, a distance along a road or other navigable path, or a grid of coordinates.

One or more users may be associated with a respective geolocated area. Associating a user with a geolocated area may grant the user access privileged to supervise, edit, or otherwise control content related to the geolocated area. In some embodiments, a single user is associated with a geolocated area and is allowed to review and edit the content related to the geolocated area. In other embodiments, multiple users are associated with a geolocated area, where each user is only allowed to review and edit content of one or more particular content types. In still other embodiments, a single or multiple users may be associated with one or more geolocated areas.

A user may be associated with one or more geolocated areas based on, for example, a point total. The point total may be stored at the user's profile and may increase or decrease based on, for example, the content provided by the user. The point total may be divided among multiple geolocated areas to which the user has contributed content. If the user's points associated with a particular geolocated area meet a threshold point total, the user may be given access privileges to edit, control, or review content related to the particular geolocated area. Additionally, as one user is granted access privileges to edit the particular geolocated area, one or more other users may be denied privileged to edit or otherwise control or review content related to the particular geolocated area.

The threshold point total needed to grant a user access privileges may be provided by a user or an administrator, or may be determined by GIS 202. In some embodiments, the threshold point total for a geolocated area may be based on the total number of points awarded to users that provided content related to the geolocated area. For example, if a first user earns more than half of the points awarded to content related to a geolocated area, the first user may have sufficient points to earn access privileges to edit, control, and review the content related to the geolocated area. Other factors may also be used to determine the threshold point values such as, for example, the number of users providing content or the popularity of the content or geolocated area.

6. Content Distributer

In some embodiments, GIS 202 also optionally includes content distributer 210. Content distributer 210 is configured to provide content to users when the users request geo-referenced data related to a geolocated area. The content may be organized by type so that each type is displayed to the users in layers. The user may then toggle whether to display certain layers. The content included each layer may be displayed with the geo-referenced data according to the geolocation associated with the content. For example, if the geo-referenced data includes a map, the content included in each layer may be represented on the map using an icon or other graphic positioned and displayed on the map according to the contents' geolocation. Information identifying the user(s) that provided the content may also be displayed with the provided content. Whether to display the user(s) with any provided content may be controlled according to privacy settings associated with the users' profile.

B. Client Application Embodiment

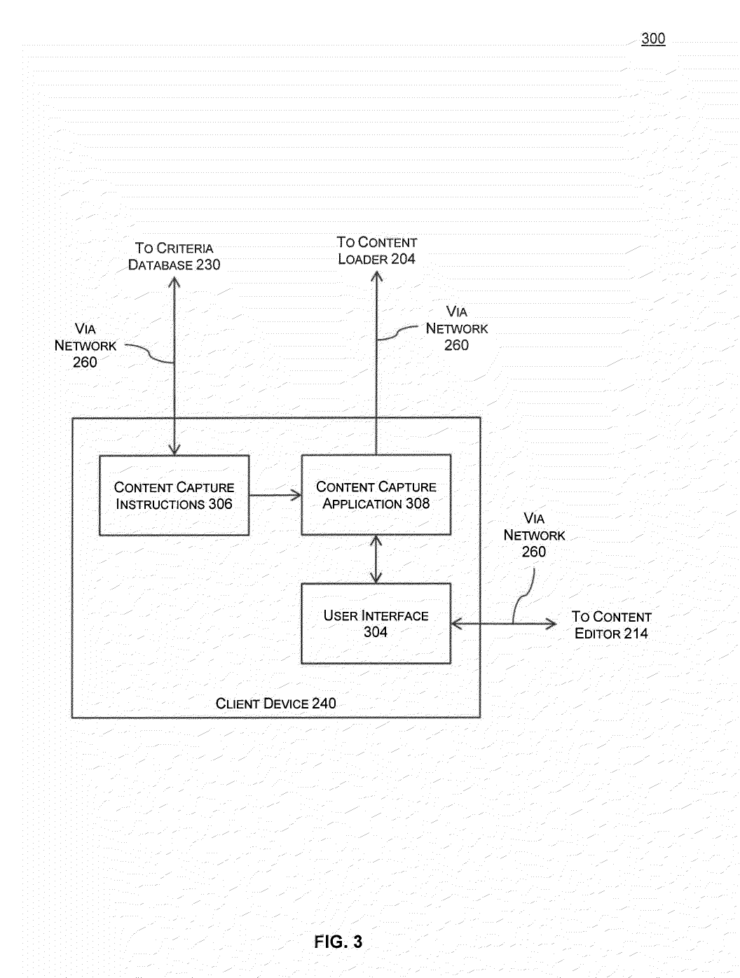

FIG. 3 illustrates an example system 300 that may be used on a client device such as, for example, client device 240 to incentivize users to contribute content in a controlled manner. System 300 includes content capture instructions 306, content capture application 308, and user interface 304. System 300 is configured to interact with GIS 202 in FIG. 2 so that information may be provided to notify a user of system 300 that content available to system 300 meets a threshold of the specific criteria. System 300 is also configured to capture or assist the user in capturing content and provide the content to GIS 202.

To notify the user of content that meets the threshold of specific criteria, content capture instructions 306 receive the specific criteria from a geographic information server such as, for example, GIS 202. The specific criteria, as described above, include, among other things, a geolocated area. The specific criteria may also include an identification of content that, if provided to GIS 202, will result in points being awarded. The awarded points may added to a user's point total or the application developer's point total.

Content capture instructions 306 may be provided to an application developer as an application programming interface (“API”). The API may allow developers to write and distribute applications (e.g., content capture application 308) that encourage users to collect specific content. For example, content capture instructions 306 may receive specific criteria from GIS 202 that indicates that points will be awarded for photographic image content captured at a variety of geolocations. Content capture application 308 may then utilize the specific criteria in a game-like setting to encourage user to collect specific photographic images. In some embodiments, content capture application 308 offers a game-like setting with an augmented reality that executes on a mobile device. As a user views data from the mobile device's camera, the content capture application 308 may display notifications to the user when a photographic image should be captured.

Content captured by content capture application 308 may be provided to GIS 202. GIS 202 may, as described above, compare the content to the specific criteria and award point to either a user of the application or a developer of the application if the content meets a threshold of the specific criteria.

Various aspects of embodiments described herein can be implemented by software, firmware, hardware, or a combination thereof. The embodiments, or portions thereof, can also be implemented as computer-readable code. The embodiments in systems 200 and 300 are not intended to be limiting in any way.

### Example Method Embodiments

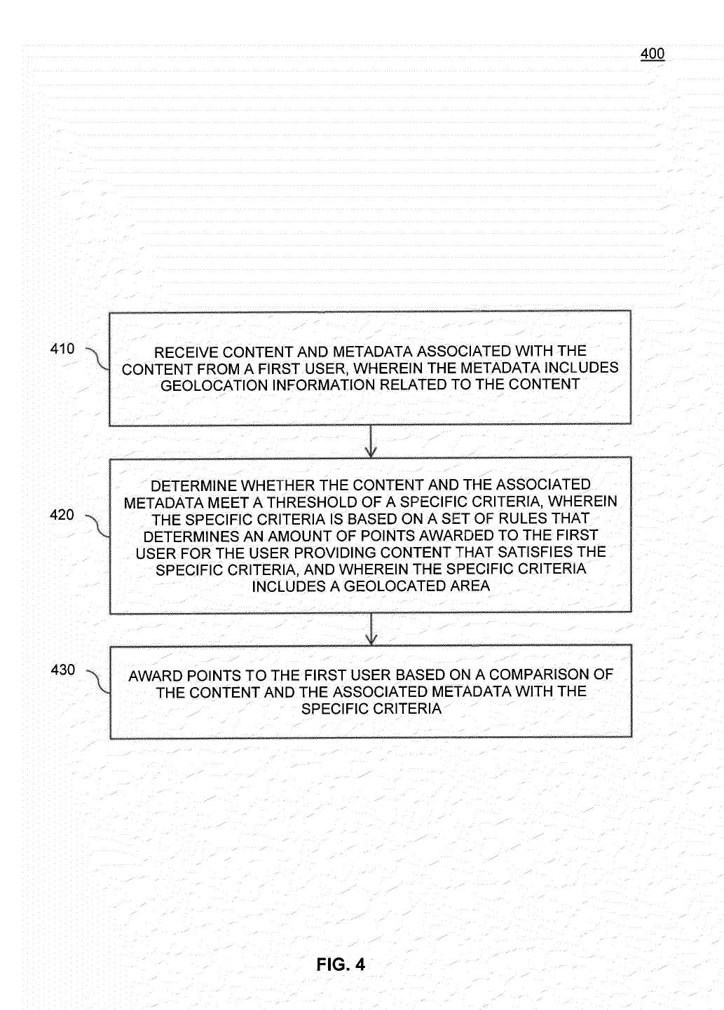

FIG. 4 is a flowchart illustrating an example method 400 for incentivizing users to contribute content in a controlled manner. While method 400 is described with respect to an embodiment, method 400 is not meant to be limiting and may be used in other applications. Additionally, method 400 may be carried out by, for example, system 200 in FIG. 2.

Method 400 receives content and metadata associated with the content from a user (stage 410). The metadata includes geolocation information related to the content. Geolocation information related to the content may depend on the type of the content. For example, geolocation information associated with a photographic image may indicate where a photo capture device was located when the photographic image was captured. Geolocation information associated with text data may indicate a business or other physical location related to the text data. Stage 410 may be carried out by, for example, content loader 204 embodied in system 200.

Method 400 then determines whether the content and the associated metadata meet a threshold of specific criteria (stage 420). The specific criteria is based on a set of rules that determines an amount of points awarded to the user for providing content that satisfies the specific criteria. The specific criteria include at least a geolocation or a geolocated area. The specific criteria may also include, for example, one or more content types or frequency of content distribution. The specific criteria may be organized by, for example, content type, geolocation, or geolocated area.

Any number of factors may be used to determine whether content and the metadata associated with the content meet the threshold of the specific criteria. For example, if the specific criteria indicate that points will be awarded for providing photographic images of a geolocated area, the threshold may be met by providing photographic images captured at geolocations within the geolocated area. Stage 420 may be carried out by, for example, content analyzer 206 embodied in system 200.

If content meets the threshold of the specific criteria, method 400 awards points to the first user based on a comparison of the content and the associated metadata with the specific criteria (stage 430). The amount of points awarded may depend on, for example, the quality of the content, the frequency of distribution of the content, or the difference between the geolocation associated with the content and the geolocation or geolocated area of the specific criteria. Stage 430 may be carried out by, for example, criteria analyzer 208 embodied in system 200.

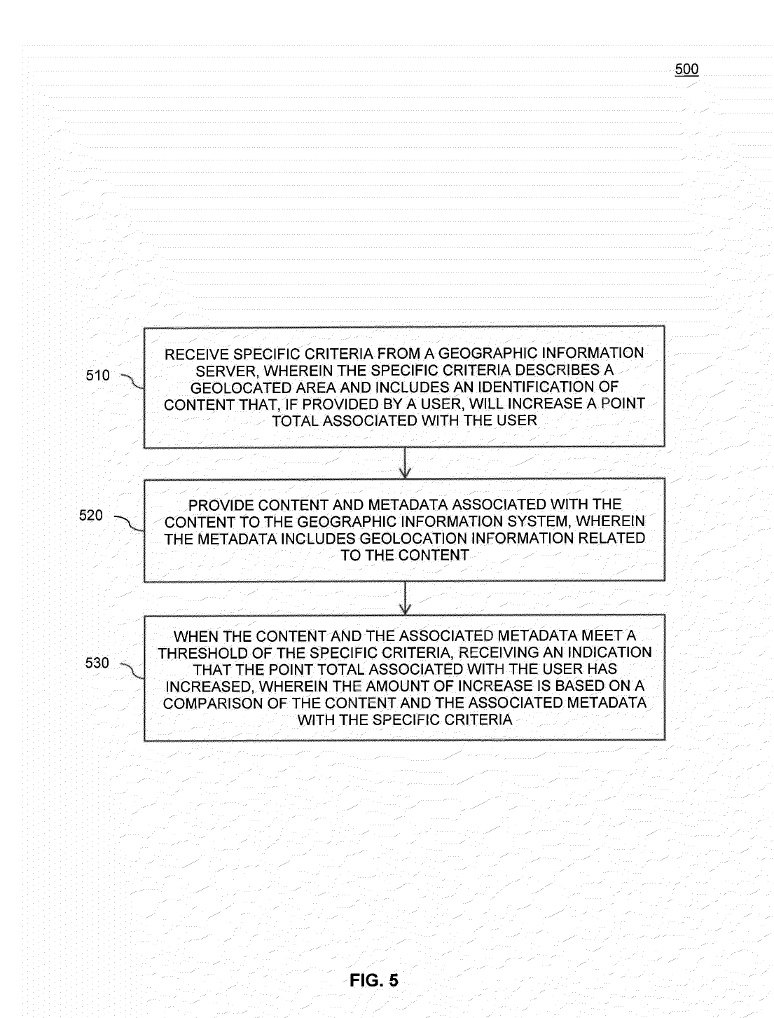

FIG. 5 is a flowchart illustrating an example method for program developers to incentivize users to contribute content in a controlled manner. While method 500 is described with respect to an embodiment, method 500 is not meant to be limiting and may be used in other applications. Additionally, method 500 may be carried out by, for example, system 300 in FIG. 3.

Method 500 receives specific criteria from a geographic information server (stage 510). The specific criteria describe at least a geolocation or geolocated area and include an identification of content that, if provided by a user, will increase a point total associated with the user. The specific criteria may be requested from the GIS using any number for network or computer communication protocols. Additionally, the specific criteria requested may be limited to a specific content type, geolocation, or geolocated area. Stage 510 may be carried out by, for example, content capture instructions 306 embodied in system 300.

The specific criteria may be used in any number of computer programs to encourage users to generate content. For example, a program that displays reviews of businesses may utilize the specific criteria to encourage users to submit reviews of specific businesses. For content created by, or provided to the computer programs, method 500 provides the content and metadata associated with the content to the GIS (stage 520). The metadata, including at least geolocation information related to the content, may be provided by the computer program. Stage 520 may be carried out by, for example, content capture application 308 embodied in system 300.

When the content and the metadata associated with the content meet a threshold of the specific criteria, method 500 receives an indication that points have been awarded (stage 530). The amount of awarded points may be based on a comparison of the content and the associated metadata with the specific criteria. The points may be awarded to a user of the computer program or the program's developer. Stage 530 may also be carried out by, for example, content capture application 308 embodied in system 300.

### Example Computer System

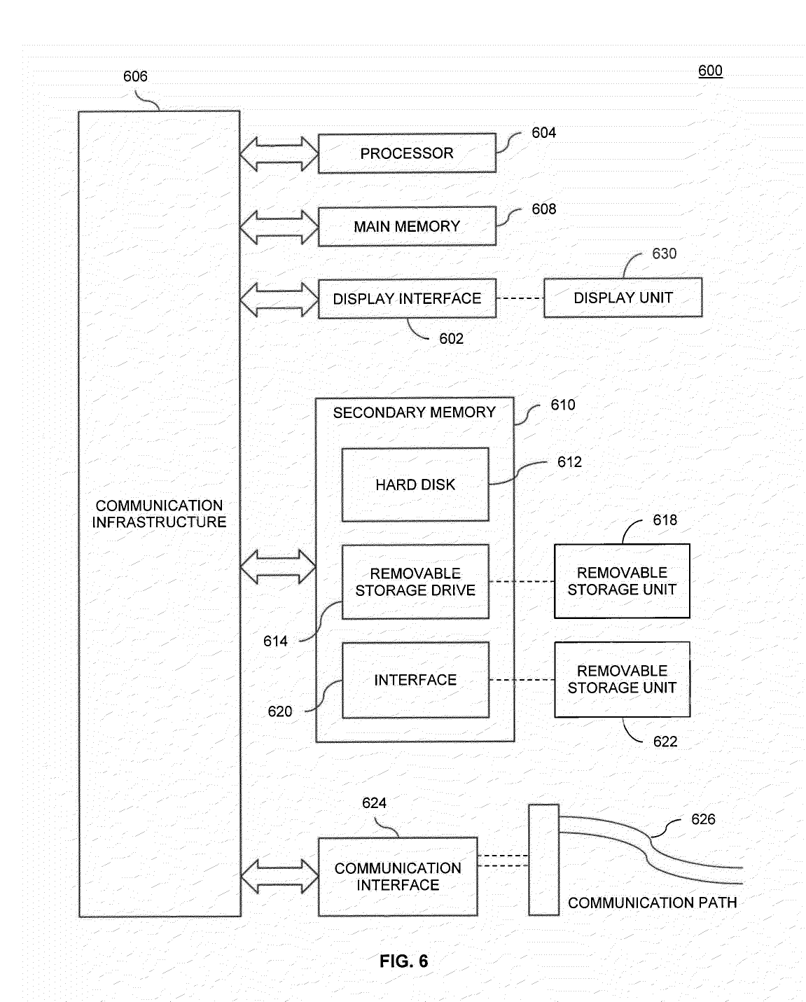

FIG. 6 illustrates an example computer 600 in which the embodiments described herein, or portions thereof, may be implemented as computer-readable code. For example, content loader 204, content analyzer 206, criteria analyzer 208, content distributer 210, criteria generator 212, or content editor 214 in FIG. 2 and content capture instructions 306 or content capture application 208 in FIG. 3 may each be implemented in one or more computer systems 600 using hardware, software, firmware, computer readable storage media having instructions stored thereon, or a combination thereof.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 604 may be a single processor in a multi-core/multiprocessor system, such system operating alone, or in a cluster of computing devices operating in a cluster or server farm. Processor device 604 is connected to a communication infrastructure 606, for example, a bus, message queue, network, or multi-core message-passing scheme. Computer system 600 may also include display interface 602 and display unit 630.

Computer system 600 also includes a main memory 608, for example, random access memory (RAM), and may also include a secondary memory 610. Secondary memory 610 may include, for example, a hard disk drive 612, and removable storage drive 614. Removable storage drive 614 may include a floppy disk drive, a magnetic tape drive, an optical disk drive, a flash memory drive, or the like. The removable storage drive 614 reads from and/or writes to a removable storage unit 618 in a well-known manner. Removable storage unit 618 may include a floppy disk, magnetic tape, optical disk, flash memory drive, etc. which is read by and written to by removable storage drive 614. As will be appreciated by persons skilled in the relevant art, removable storage unit 618 includes a computer readable storage medium having stored thereon computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 618, removable storage unit 622, and a hard disk installed in hard disk drive 612. Computer storage medium and computer readable storage medium may also refer to memories, such as main memory 608 and secondary memory 610, which may be memory semiconductors (e.g. DRAMs, etc.).

Computer programs (also called computer control logic) are stored in main memory 608 and/or secondary memory 610. Computer programs may also be received via communications interface 624. Such computer programs, when executed, enable computer system 600 to implement the embodiments described herein. In particular, the computer programs, when executed, enable processor device 604 to implement the processes of the embodiments, such as, for example, the stages in the methods illustrated by flowcharts 400 of FIGS. 4 and 500 of FIG. 5, described above. Accordingly, such computer programs represent controllers of computer system 600. Where an embodiment is implemented using software, the software may be stored in a computer storage medium and loaded into computer system 600 using removable storage drive 614, interface 620, and hard disk drive 612, or communications interface 624.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### CONCLUSION

The Summary and Abstract sections may set forth one or more but not all exemplary embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

1. A computer-implemented method for incentivizing users to contribute content to a geographic information system in a controlled manner comprising:
receiving, by at least one computer processor, content and metadata associated with the content from a first user, wherein the content is related to a geolocation, and wherein the metadata includes geolocation information related to the content;
determining, by the at least one computer processor, whether the content and the associated metadata meet a threshold of a specific criteria, wherein the specific criteria is based on a set of rules that determines an amount of points awarded to the first user for the user providing content that satisfies the specific criteria, and wherein the specific criteria includes at least a geolocation; and
awarding, by the at least one computer processor, points to the first user based on a comparison of the content and the associated metadata with the specific criteria.

2. The computer-implemented method of claim 1, wherein the specific criteria includes a distance value, and wherein awarding points to the user includes determining, from the geolocation associated with the content, whether the content is spaced across the geolocation range approximately at the distance value.

3. The computer-implemented method of claim 1, wherein the specific criteria includes one or more geolocations, and wherein awarding points to the user includes determining whether the geolocation associated with the content is approximate to one or more of the geolocations of the specific criteria.

4. The computer-implemented method of claim 1, further comprising:
when the first user's points meet a threshold point total, associating the first user with the geolocated area of the specific criteria; and
providing to a second user the first user's content with geo-referenced data that corresponds to the geolocated area.

5. The computer-implemented method of claim 1, further comprising:
when the first user's points meet a threshold point total, providing the first user with sufficient access privileges to edit content received by other users that corresponds to the geolocated area.

6. The computer-implemented method of claim 1, wherein the content includes one or more of photographic images, editorial reviews, business names, physical addresses, menus, pricing, or other information about the geolocation associated with content.

7. The computer-implemented method of claim 1, further comprising:
generating a plurality of specific criteria, each specific criteria corresponding to a respective geolocated area, wherein each specific criteria is based on the set of rules.

8. The computer-implemented method of claim 1, further comprising:
generating a plurality of specific criteria, each specific criteria corresponding to the same geolocated area, wherein each specific criteria is based on the set of rules; and wherein each specific criteria includes a content type.

9. The computer-implemented method of claim 8, wherein awarding points to the user includes determining whether the geolocation associated with content falls within the geolocated area and determining whether the content's type satisfies the content type of at least one specific criteria of the geolocated area.

10. A geographic information system that incentivizes users to contribute content in a controlled manner comprising:
a memory configured to store computer-implemented instructions; and
one or more processors coupled to the memory and configured to execute the computer-implemented instructions to:
receive content and metadata associated with the content from a first user, wherein the content is related to a geolocation, and wherein the metadata includes geolocation information related to the content;
determine whether the content and the associated metadata meet a threshold of a specific criteria, wherein the specific criteria is based on a set of rules that determines an amount of points awarded to the first user for the user providing content that satisfies the specific criteria, and wherein the specific criteria includes at least a geolocation; and
award points to the first user based on a comparison of the content and the associated metadata with the specific criteria.

11. The geographic information system of claim 10, wherein the specific criteria includes a distance value, and wherein the one or more processors are further configured to determine, from the geolocation associated with the content, whether the content is spaced across the geolocation range approximately at the distance value.

12. The geographic information system of claim 10, wherein the specific criteria includes one or more geolocations, and wherein the one or more processors are further configured to determine whether the geolocation associated with the content is approximate to one or more of the geolocations of the specific criteria.

13. The geographic information system of claim 10, further comprising:
the one or more processors further configured to, when the first user's points meet a threshold point total, associate the first user with the geolocated area of the specific criteria; and
the one or more processors further configured to provide to a second user the first user's content with geo-referenced data that corresponds to the geolocated area.

14. The geographic information system method of claim 10, further comprising:
the one or more processors further configured to, when the first user's points meet a threshold point total, provide the first user with sufficient access privileges to edit content received by other users that corresponds to the geolocated area.

15. The geographic information system of claim 10, wherein the content includes one or more of photographic images, editorial reviews, business names, physical addresses, menus, pricing, or other information about the geolocation associated with content.

16. The geographic information system of claim 10, further comprising:
the one or more processors further configured to generate a plurality of specific criteria, each specific criteria corresponding to a respective geolocated area, wherein each specific criteria is based on the set of rules.

17. The geographic information system of claim 10, further comprising:
the one or more processors further configured to generate a plurality of specific criteria, each specific criteria corresponding to the same geolocated area, wherein each specific criteria is based on the set of rules; and
wherein each specific criteria includes a content type.

18. The geographic information system of claim 17, wherein the one or more processors are further configured to:
determine whether the geolocation associated with content falls within the geolocated area; and
determining whether the content's type satisfies the content type of at least one specific criteria of the geolocated area.

19. A computer programming interface including instructions that, when executed by a computer processor, cause the computer processor to carry out a method comprising:
receiving specific criteria from a geographic information server, wherein the specific criteria describes a geolocated area and includes an identification of content that, if provided by a user, will increase a point total associated with the user;
providing content and metadata associated with the content to the geographic information system, wherein the metadata includes geolocation information related to the content;
when the content and the associated metadata meet a threshold of the specific criteria, receiving an indication that points have been awarded, wherein the amount of awarded points is based on a comparison of the content and the associated metadata with the specific criteria.

20. The computer programming interface of claim 19, wherein the instructions are included in an executable computer program configured to capture content within the geolocated area, and wherein the content that generates the greatest point total increase is indicated by the computer program.
